(19) United States
(12) Patent Application Publication
(10) Pub. No.: US 2008/0008207 A1
(43) Pub. Date: Jan. 10, 2008

(54) One-way data link for secure transfer of information

(76) Inventor: Charles W. Kellum, (US)

Correspondence Address: Ralph A. Dowell of DOWELL & DOWELL P.C., 2111 Eisenhower Ave, Suite 406, Alexandria, VA, 22314, US

(21) Appl. No.: 11/819,701

(22) Filed: Jun. 28, 2007

Related U.S. Application Data
(60) Provisional application No. 60/816,877, filed on Jun. 28, 2006.

(51) Int. Cl. H04J 3/17

(52) U.S. Cl. 370/433

(57) ABSTRACT

A one-way data communication link implementation method and system are presented. It is used to insure no covert channels exist between a transmitter system and receiver system. Covert channels can be used to pass information, for unauthorized purposes. Thus covert channels must be eliminated, if an information system or network is to be considered secure. The one-way link is an essential security tool for constructing secure information systems and networks. An example use of a one-way link is given for a system which acts as a communications front-end (CFE) module to a system it is protecting. The one-way link is use to transfer data in only a single direction from a protected system to the CFE-Module.

### CROSS REFERENCE TO RELATED APPLICATIONS

This application is based upon and claims the benefit of U.S. Provisional application 60/816,877, filed Jun. 28, 2006, in the name of the same inventor, the entire contents of such application are incorporated herein by reference.

### BACKGROUND OF THE INVENTION

1. Field of the Invention

Effective Information-system Security (InfoSec) requires control of signal traffic from, to, and within an information system or information network. To achieve required signal flow control, one-way data links are often required. To implement such a data link, a unidirectional signal path must first be constructed. The present invention is directed to creating such unidirectional signal paths. These signal paths are the basis for a true one-way data link.

2. Brief Discussion of the Related Art

Generally, one-way data links have been seldom used in constructing secure communication and data transfer networks. Software programs have been used to implement pseudo one-way links, wherein the data-transfer is only in one direction. However, signal traffic actually may occur in both directions (e.g. the handshake sequence between a transceiver pair). This signal traffic is exploitable using covert-channels, thus allowing information to be passed in a reverse direction by hostile entities. Fully effective one-way data links can only be accomplished by way of hardware architecture.

### SUMMARY of INVENTION

The present invention is to one-way data or communication links. It permits signal transfer in only one direction. Thus, the handshake sequence, between a transmitter and receiver, must be altered to function in an operational-envelope that allows only one-way control-signal traffic. The handshake sequence alteration is a device driver issue, and can be addressed by timing of specific driver functions. The signal path's physical architecture can be addressed by configuring appropriate connector-pin to a true (i.e. always-active) state. Thus the device driver can be altered in a straightforward manner, allowing the one-way signal path to function as a normal (to standard components) communications link for one-way data transfers. BRIEF DESCRIPTION OF THE DRAWINGS

A better understanding of the invention will be had with reference to the accompanying drawings wherein:

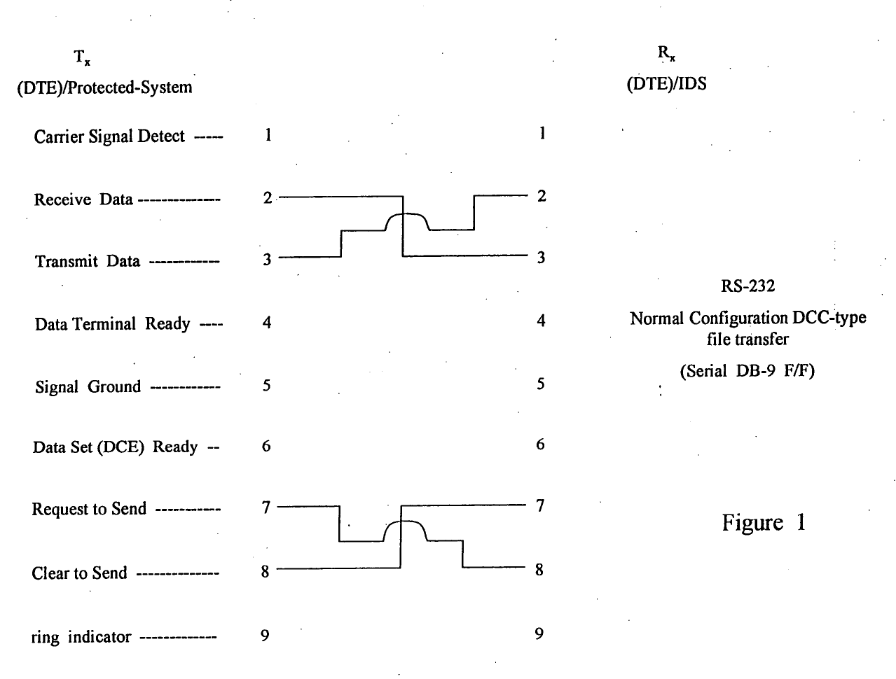

FIG. 1 is a connection diagram of a conventional communications link structure;

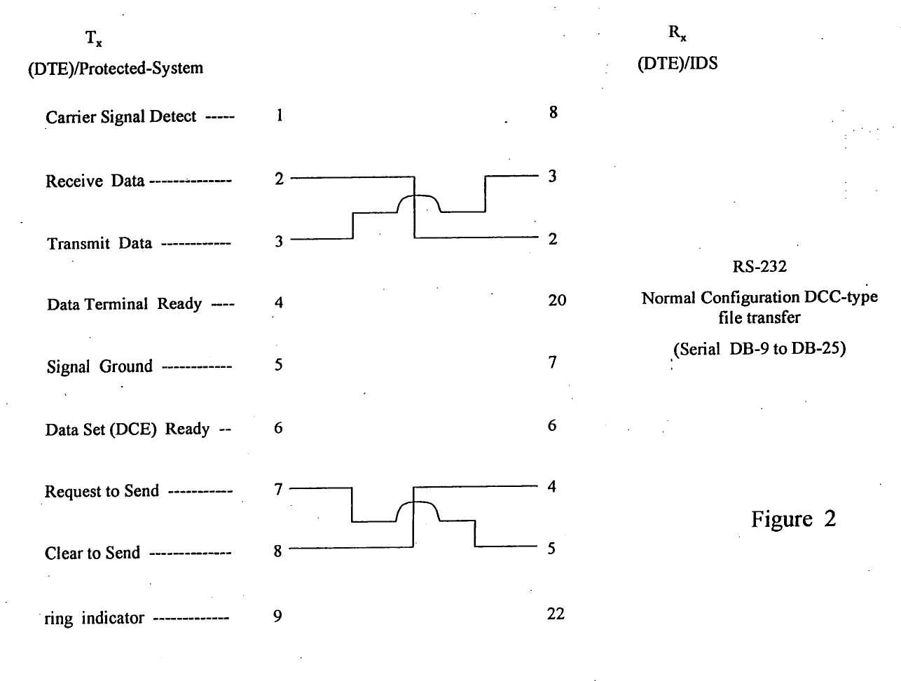

FIG. 2 is another connection diagram of a conventional communications link structure;

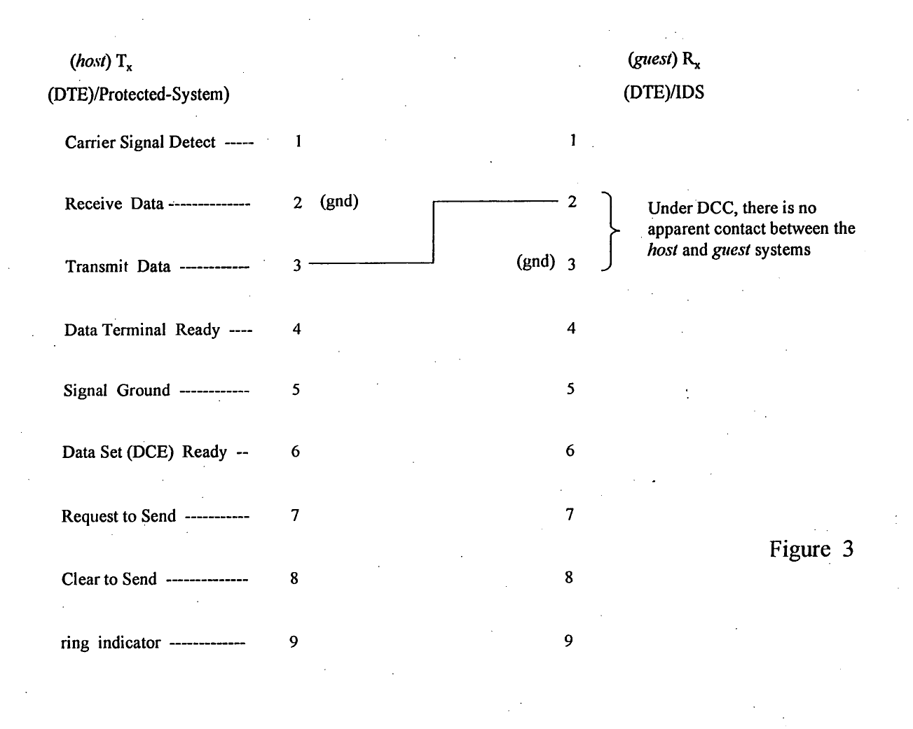

FIG. 3 is a connection diagram showing a hard wire form of a one-way signal path in accordance with the invention;

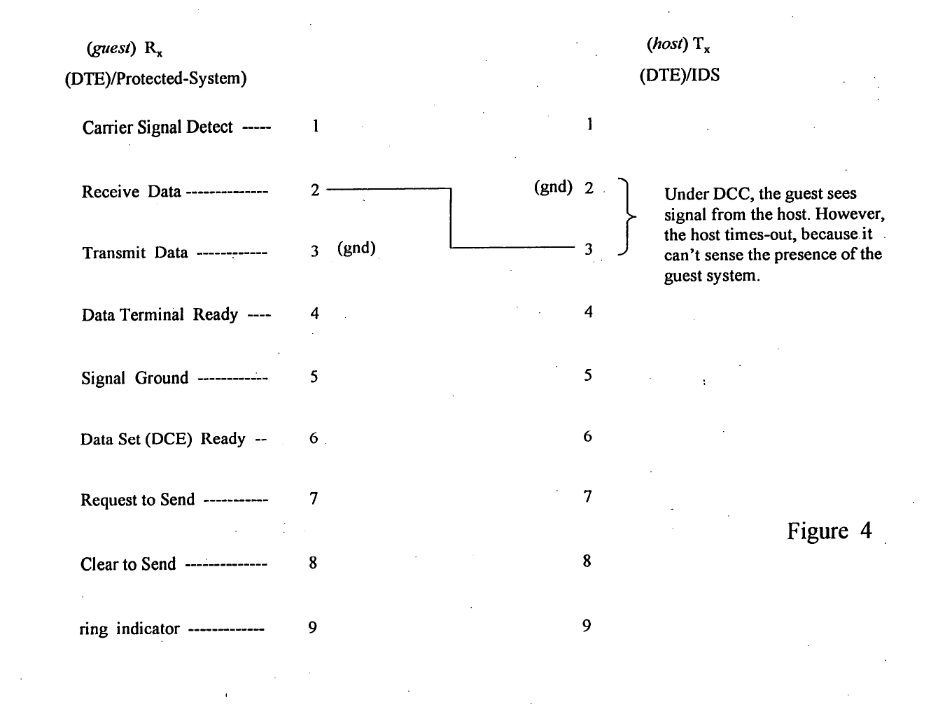

FIG. 4 is another embodiment of a connection diagram showing a hard wire form of a one-way signal path in accordance with the invention;

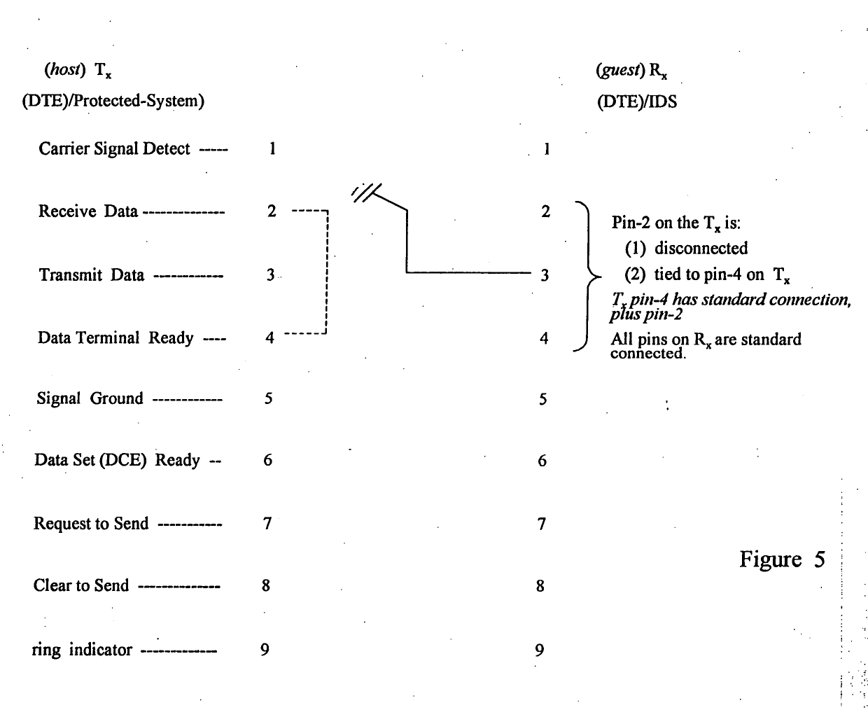

FIG. 5 is a connection diagram showing one manner of disrupting the reverse signal path from the receiver to the transmitter for use with systems such as shown in FIGS. 1 and 2 using conventional software in accordance with the invention;

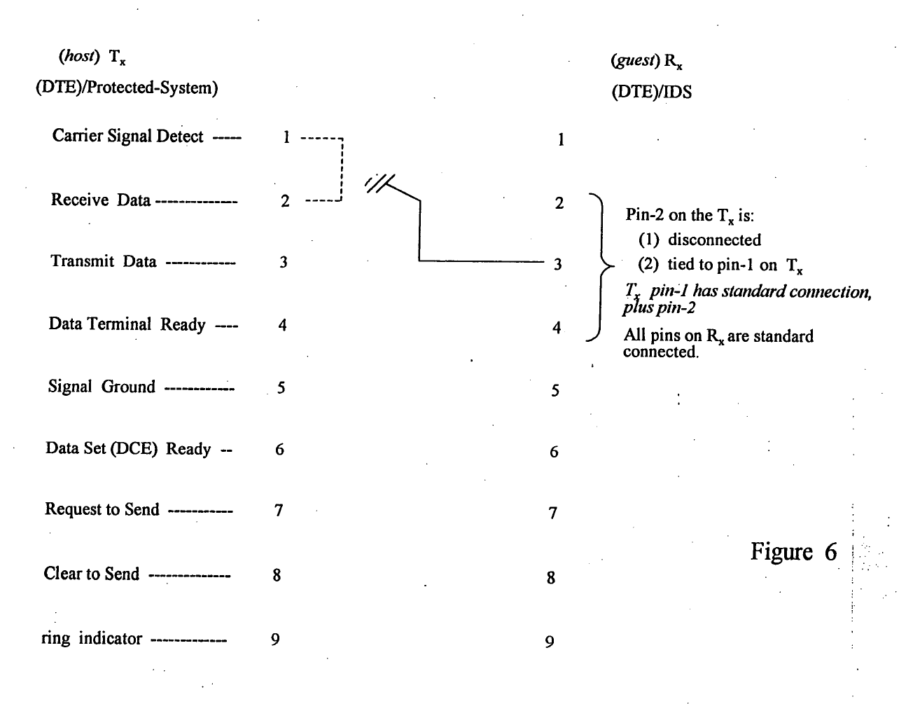

FIG. 6 is a further variation of the embodiment of FIG. 5; and

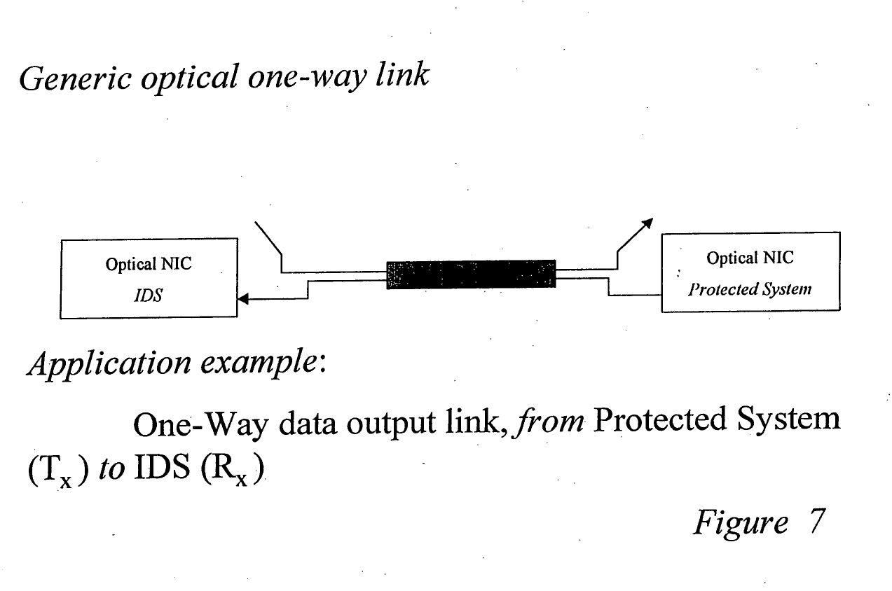

FIG. 7 illustrates an optical one-way communication and data link in accordance with the invention.

### DESCRIPTION OF THE PREFERRED EMBODIMENTS

In conventional one-way communication and data transfer links as illustrated in FIGS. 1 and 2, either a hard wire or radio frequency communication signal path is created between a protected transmitter system Tx and a signal receiving system Rx. FIG. 1 illustrates a RS-232 system having a serial DB-9 configuration. To initiate a transfer of communication or data signals from the transmitter Tx to the receiver Rx, the transmitter initiates a hand shake protocol wherein a signal from pin 7 is sent to pin 8 of the receiver to the effect of a request to send. The receiver being activated by the request to send completes the hand shake by a reverse signal from it's pin 7 to pin 8 of the transmitter that it is clear to send. At this time, the transmitter sends the communication or data signals from it's pin 3 to pin 2 of the receiver with the receiver acknowledging receipt by reverse communication from it's pin 3 to pin 2 of the transmitter. During this procedure, there are two reverse signal transmissions that could possibly be used to send corrupted signals from the receiver to the transmitter.

FIG. 2 illustrates a RS-232 system having a serial DB-9 to DB-25 configuration. To initiate a transfer of communication or data signals from the transmitter Tx to the receiver Rx, the transmitter initiates a hand shake protocol wherein a signal from pin 7 is sent to pin 5 of the receiver to the effect of a request to send. The receiver being activated by the request to send completes the hand shake by a reverse signal from it's pin 4 to pin 8 of the transmitter that it is clear to send. At this time, the transmitter sends the communication or data signals from it's pin 3 to pin 2 of the receiver with the receiver acknowledging receipt by reverse communication from it's pin 3 to pin 2 of the transmitter. Again, during this procedure, there are two reverse signal transmissions that could possibly be used to send corrupted signals from the receiver to the transmitter. Such reverse signal paths create covert channels that are a tool with which to clandestinely pass information between systems and over a network.

The one-way data link defined by the present invention operates at the signal-level of a system. It insures that signal transfer occurs only in one direction between a transmitter and a receiver. The fact that no signal-path exists in the reverse direction, insures that no covert-channels exist in the reverse direction and thus corrupted signals can not be sent to the transmitter. The following description details the physical structure of, and control/drivers for, operational one-way links. Such one-way links are a primary tool for constructing secure information systems and information networks.

A one-way data link is a hardware-based security tool. It is used to transfer data in one direction (e.g. to a device), and prevent any information transfer from the receiving device Rx to the transmitting device Tx. Such reverse signal transfer from an a receiver Rx to a transmitter Tx is usually done during the handshake sequence between transceiver pairs as previously described.

Security sensitive applications often require that no information transfer takes place from the receiver to the transmitter, including during a handshake sequence. Such information transfer can be used as a timing-channel and/or signaling-channel. To eliminate the possibility of covert-channels, a one-way link can be used. Thus, one-way links are a valuable tool for the implementation of secure networks and systems. As is shown in FIGS. 3-7, a true one-way link is a hardware security tool. It allows no covert channels to exist in the reverse direction, from a receiver to a transmitter, including handshake sequence signals. A one-way link can not be achieved with software alone.

FIGS. 3 and 4 illustrate both the simplicity of configuring a one-way link, and the necessity for special driver software. The direct cable connection (DCC) applications shown are good test vehicles, in that they require a standard link for a data/file transfer process. The hardware configurations must be made to appear as conventional or standard data links to the DDC program. That is, conventional software associated with such systems will not properly function using the hardware configuration of FIGS. 3 and 4 because each device (host-system and guest-system) must execute a standard handshake sequence on pin-2 of the receiver. The creation of special driver software is the simplest way to permit the hardware connection of FIGS. 3 and 4 so that the system does not react adversely to the one-way connection. A DB-9 configuration is illustrated, however, the DB-25 configuration could be addressed in a similar manner.

As is shown in FIGS. 3 and 4, there is only a single connection between the transmit pin 3 of the transmitter or host Tx and the receive pin 2 of the receiver or guest Rx. Software is used to create a simulated handshake and acknowledgement routine for both the transmitter and the receiver when in fact only the transmitted signal is communicated through the connection there between. Thus, there is no reverse signal path that can be used to send corrupted signals from the receiver to the transmitter.

FIGS. 5 and 6 illustrate systems to permit the transmitter and the receiver to be connected effectively as shown in FIGS. 3 and 4 to disrupt the reverse signal path but without allowing the conventional software used with the data link to react to lack of physical connection of the receiver to communicate in the reverse direction to the transmitter. The connections of FIGS. 5 and 6 are essentially overlays used in combination with the diagrams of FIGS. 3 and 4.

In FIG. 5, the receive data pin 2 of the transmitter Tx is not connected to the receiver but is connected to the data terminal pin 4 while the transmit pin 3 of the receiver is not connected to the transmitter but is connected to ground. These connections in effect permit the conventional software associated with the system to function in the one-way manner without the possibility of reverse signals possibly being sent by the receiver Rx to corrupt the transmitter Tx.

In FIG. 6, the receive data pin 2 of the transmitter Tx is not connected to the receiver but is connected to the carrier signal detect pin 1 of the transmitter while the transmit pin 3 of the receiver is not connected to the transmitter but is connected to ground. These connections in effect permit the conventional software associated with the system to function in the one-way manner without the possibility of reverse signals possibly being sent by the receiver Rx to corrupt the transmitter Tx.

With an optical communication or data link, it is a simple matter to physically disable one of the links that permit signal flow in opposite directions. This could merely involve a disconnection of one of the links. The driver software would have to be adjusted, however. Such a one-way link can be created using optically-capable NIC-cards. The Intel PRO/1000F Server Adapter is such an optical-capable network card. The adjusted driver software can be constructed by most competent software vendors. An illustration of an optical one-way link is given in FIG. 7. As shown, an optical NIC functioning as a protected system or the transmitter Tx is optically coupled to an Optical NIC functioning as a receiver. The optical link to the receiver is shown connected whereas the reverse link is shown as disconnected.

There are generic device-diver software guidelines that should be considered. Details of software drivers are obviously device & operating-system specific. Generally, driver software can be interrupt-driven, for operational efficiency normal enter-device handshake sequences must be altered or bypassed:

### EXAMPLE;

at Tx
activate request-to-send signal tr
clear-to-send (always ready/true)
transmit at a time At after request-to-send signal detection

at Rx
after request-to-send signal is detected (time t)
data transfer begins at/after specific time period t_{d} (where; t_{d}>Δt+Φ, Given; Φ=|t−tᵣ|
time interval At is used to configure the Rx for data input.

For an optical link, the software code driving the reverse link is disabled in a manner appropriate to a specific optical connection and to the application involved.

It is expected that the present invention and many of its attendant advantages will be understood from the foregoing description and it will be apparent that various changes may be made in form, construction, and arrangement of the components and modules thereof, without departing from the spirit and scope of the invention or sacrificing all of its advantages, the forms hereinbefore described being merely preferred or exemplary embodiments thereof.

I claim:

1. A method to insure one-way transfer of signals over a data communications link, in such manner as to prevent signal traffic in a reverse direction data path from a primary data transfer, wherein the primary data transfer is from a transmitter device (Tx) to a receiver device (Rx).

2. The method of claim 1, wherein the reverse direction data path is physically disabled, thus preventing signal transfer in the reverse direction from the primary data transfer.

3. The method of claim 1, wherein a handshake sequence between a transmitter/receiver pair of devices is altered in such a manner as to prevent signal transfer from the receiver device (Rx) to the transmitter device (Tx), wherein this reverse direction data path elimination process, prevents hostile techniques such as timing-channel exploitation and signaling channel exploitation, whereby timing channels and signaling channels are covert channels.

4. A system to enable one-way signal transfer between a receiver device (Rx) and a transmitter device (Tx), wherein the active signal path is from the transmitter device (Tx) to the receiver device (Rx), such that any signal transfer in a reverse direction from the receiver device (Rx) to the transmitter device. (Tx)) is prevented thereby covert channel exploitation in the reverse direction is eliminated.

5. The system of claim 4, wherein the data transfer between the transmitter device (Tx) and the receiver device (Rx) is accomplished in the manner of a standard information transfer process from a transmitter device (Tx) to a receiver device (Rx), wherein any reverse direction signal transmission is prevented.
